(19) United States
(12) Patent Application Publication
(10) Pub. No.: US 2014/0074664 A1
(43) Pub. Date: Mar. 13, 2014

(54) SYSTEM TO PURCHASE PRODUCTS SEEN IN CONTENT MEDIA

(71) Applicant: Yaakov AMSALEM, Zichron Yaakov (IL)

(72) Inventor: Yaakov AMSALEM, Zichron Yaakov (IL)

(21) Appl. No.: 13/608,492

(22) Filed: Sep. 10, 2012

(51) Int. Cl. G06Q 30/00

(52) U.S. Cl. 705/27.1

(57) ABSTRACT

A system for purchasing products from content media, the system comprising: a website portal configured to interface with one or a plurality of sellers and one or a plurality of buyers; a device configured to interface with the website portal; the device configured to synchronize with the content media; an interface for one or a plurality of buyers to purchase a product seen in the content media.

### FIELD OF THE INVENTION

The present invention relates to commercializing aspects of popular media and culture. In particular, the invention relates to a system to purchase products seen in content media.

### BACKGROUND OF THE INVENTION

Since 1977 and the release of Star Wars: Episode IV—A New Hope, the notion that consumers would pay for items related to movies,—“merchandising, merchandising, where the real money from the movie is made,” in the words of Mel Brooks a satirist of Star Wars, has become part of process of making and profiting from movies and other popular culture media. Typically those items are licensed to commercial tie-ins and other efforts to further commodify plot lines. Most merchandise sold is readily identifiable with the particular movie, either through markings or through the products relative importance to the movie.

With production costs of motion pictures rising into the hundreds of millions, and with even television, music and advertising demanding larger production budgets, producers look toward merchandising as a revenue generator. Movie merchandising and other promotional tie-ins generate billions of dollars in annual revenue to the industry.

It is therefore an object of the present invention to provide a system configured to vertically integrate content producers, retailers and web-based consumer commercial portals to commodify elements of media content.

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1a is a schematic illustration of an integrated system to purchase products seen in content media, according to an embodiment of the invention;

FIG. 1b. schematically depicts a relationship between a website portal and buyers and sellers within an integrated system to purchase products seen in content media, according to an embodiment of the invention;

FIG. 1c is a schematic illustration of a potential interface for sellers of a product within an integrated system to purchase products seen in content media, according to an embodiment of the invention;

FIG. 1d is a schematic illustration of the software for a seller within an integrated system to purchase products seen in content media, according to an embodiment of the invention;

FIG. 2 is a schematic illustration of the interrelationships within a seller group within an integrated system to purchase products seen in content media, according to an embodiment of the invention;

FIG. 3 is a schematic illustration of an interaction with a buyer within an integrated system to purchase products seen in content media, according to an embodiment of the invention;

FIG. 4 is a schematic illustration of a method using a device at a location, within an integrated system to purchase products seen in content media, according to an embodiment of the invention;

FIG. 5 is a schematic illustration of method using a device at a location within an integrated system to purchase products seen in content media, according to an embodiment of the invention;

FIG. 6 is a schematic illustration of a method for media content capture within an integrated system to purchase products seen in content media, according to an embodiment of the invention;

FIG. 7 is a schematic illustration of a device resembling eyeglass for use within an integrated system to purchase products seen in content media, according to an embodiment of the invention;

FIG. 8 is a schematic illustration of a handheld device for use within an integrated system to purchase products seen in content media, according to an embodiment of the invention;

FIG. 9 is a schematic illustration of a device resembling a pen for use within an integrated system to purchase products seen in content media, according to an embodiment of the invention;

FIG. 10 is a schematic illustration of a device resembling a ring for use within an integrated system to purchase products seen in content media, according to an embodiment of the invention;

FIG. 11 is a schematic illustration of a device resembling a watch for use within an integrated system to purchase products seen in content media, according to an embodiment of the invention;

FIG. 12 is a schematic illustration of a device resembling an ear piece for use within an integrated system to purchase products seen in content media, according to an embodiment of the invention; and,

FIG. 13 is a schematic illustration of a device coupled to a seat for use within an integrated system to purchase products seen in content media, according to an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS

In the following detailed description, numerous specific details are set forth in order to provide a thorough understanding of the methods and apparatus. However, it will be understood by those skilled in the art that the present methods and apparatus may be practiced without these specific details. In other instances, well-known methods, procedures, and components have not been described in detail so as not to obscure the present methods and apparatus.

Although the examples disclosed and discussed herein are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method examples described herein are not constrained to a particular order or sequence. Additionally, some of the described method examples or elements thereof can occur or be performed at the same point in time.

Unless specifically stated otherwise, as apparent from the following discussions, it is appreciated that throughout the specification, discussions utilizing terms such as “adding”, “associating” “selecting,” “evaluating,” “processing,” “computing,” “calculating,” “determining,” “designating,” “allocating” or the like, refer to the actions and/or processes of a computer, computer processor or computing system, or similar electronic computing device, that manipulate, execute and/or transform data represented as physical, such as electronic, quantities within the computing system's registers and/or memories into other data similarly represented as physical quantities within the computing system's memories, registers or other such information storage, transmission or display devices.

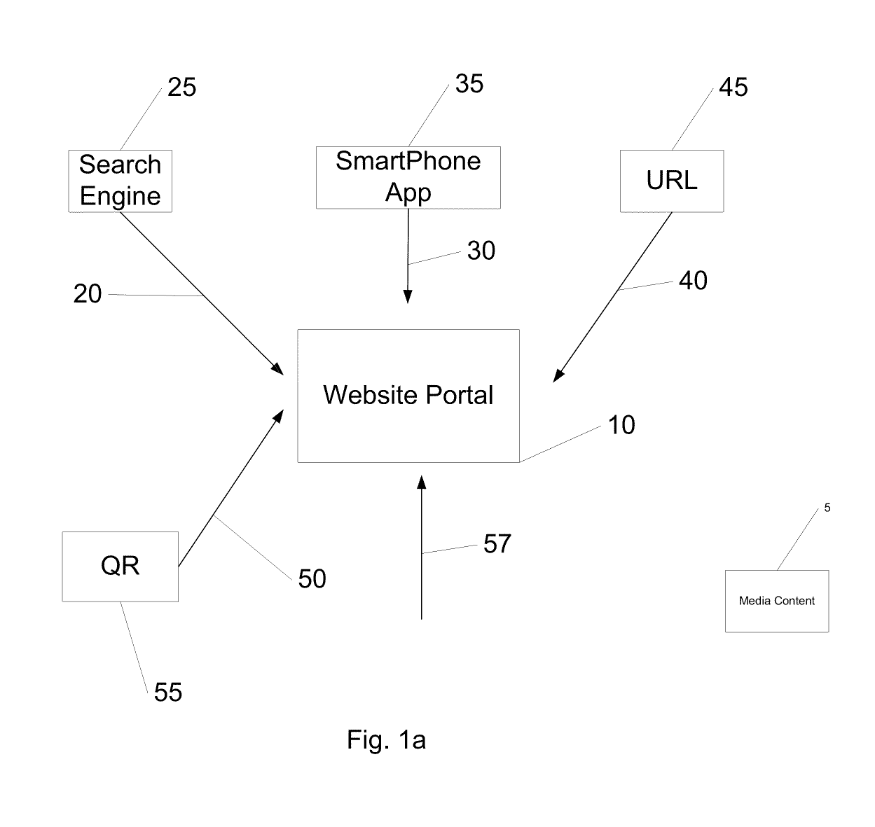

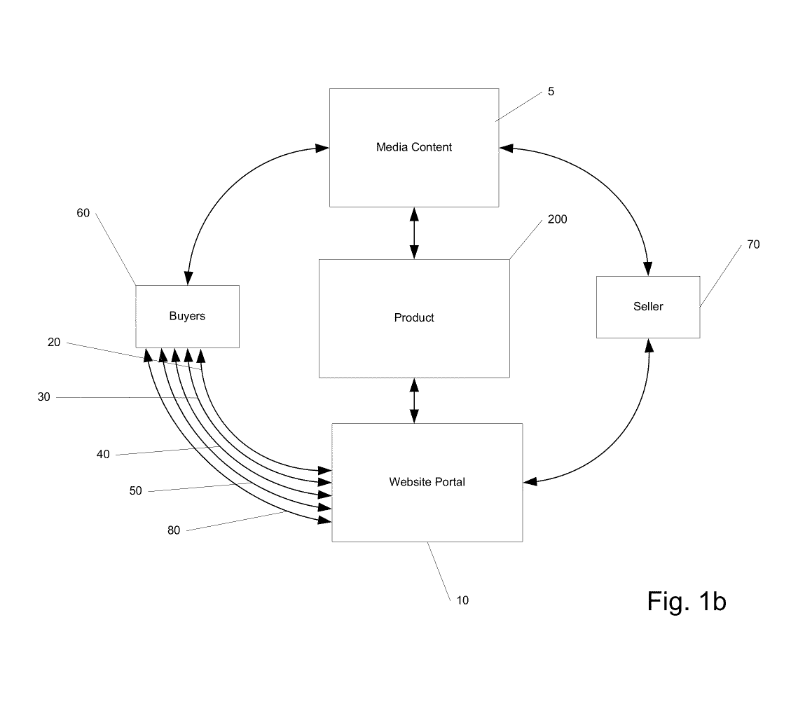

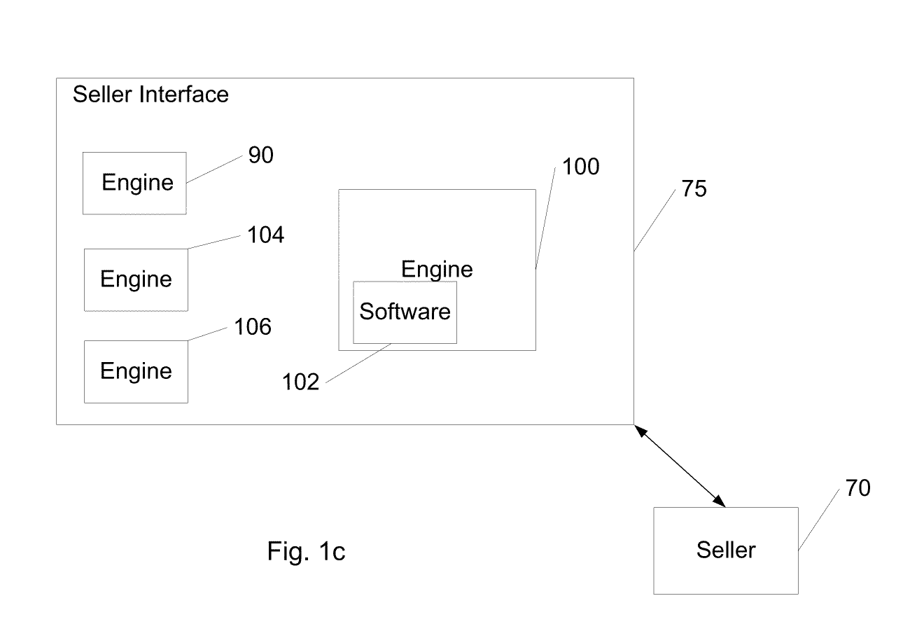

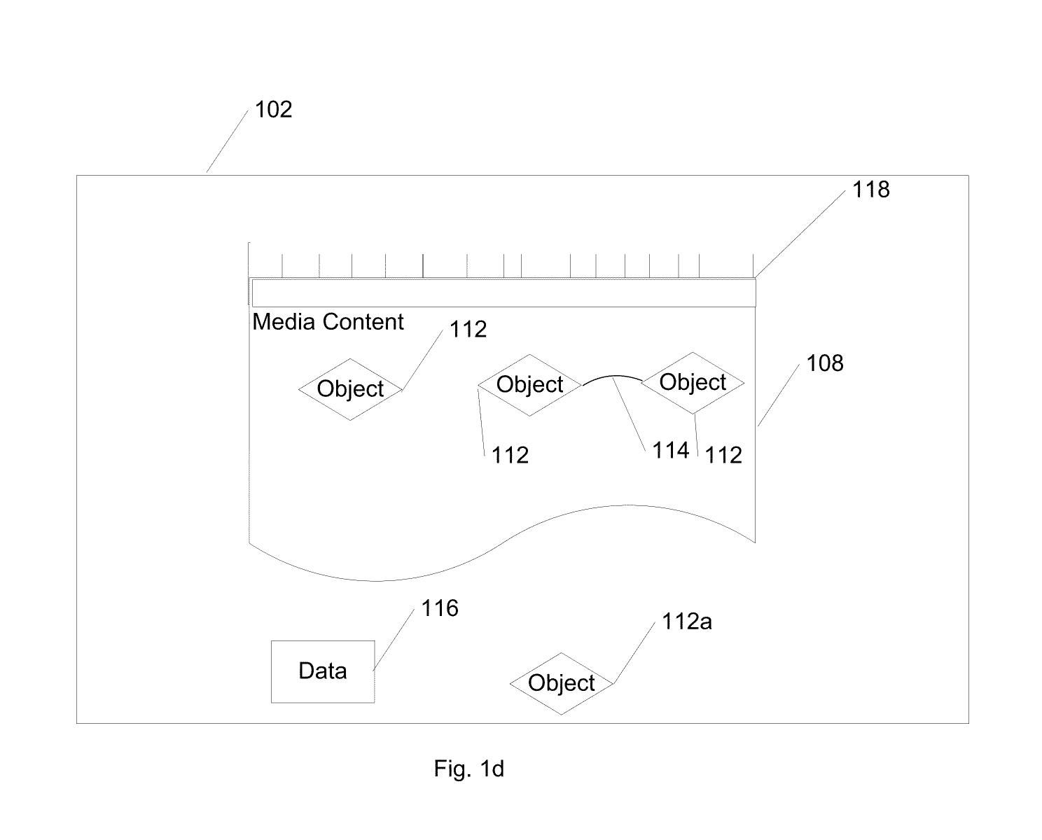

FIG. 1a is a schematic illustration of an integrated system to purchase products seen in content media, according to an embodiment of the invention.

A website portal 10 may provide a commercial interface for consumers to see and purchase products online Website portal 10 may provide an interface for consumers to purchase products seen within media content 5. In some examples, consumers may purchase products associated with products seen within content media. In some examples, consumers may purchase products non-associated with products seen within content media 5.

In some embodiments of the invention, website portal 10 or the one or plurality of companies represented by website portal 10 may have an exclusive agreement with content media and their producers, providers, and others associated with the content media, to sell products associated with the content media.

In some embodiments of the invention, website portal 10 or the one or plurality of companies represented by website portal 10 may provide incentives to media content 5, their producers, providers and other associated with the content media, to sell products associated with the content media on or through website portal 10. Media content 5 may include motion pictures, television, music video, advertising, online videos and other media content 5. The incentives may include commissions on sales. In some examples, no incentives may be provided outside of virtual space and/or particular virtual locations for use in selling or advertising products on website portal 10.

The consumer may reach and/or access the website through a number of pathways. In some examples, a first pathway 20 may include a consumer reaching website portal 10 after searching for a product in a search engine 25. In some examples, this may include advertising on a search engine site, and/or optimizing website portal 10 for use within one or a plurality of search engines.

A second pathway 30 may include a consumer reaching website portal 10 through a smartphone software package or application 35. The software package or application may be advertised in movie theaters, on television, through product placement, through viral marketing, within content media or other methods. Software package or application may be downloaded through imaging a code, e.g., a quick response (QR) code made viewable in movie theaters, on television, through product placement, through viral marketing, within content media or via other methods.

A third pathway 40 may include a consumer reaching website portal 10 through typing in a website address 45 into a web browser. In some examples, the website address may be provided with media content 5 viewed by the consumer. In some examples, external paraphernalia related to media content 5, for example a box of popcorn in a theatre, other forms of advertising, or other methods of providing a website address to a consumer may be used to inform the consumer of the link for a website.

A fourth pathway 50 may include a QR code 55 or other matrix and/or two-dimensional barcode. In some examples, a portable computing device with a camera may be employed to take a picture of QR code 55, and automatically, semi-automatically or manually prompt the consumer to, access a website.

Other pathways 80 may also lead a consumer to website portal 10.

Pathway 20 may include configuring and search engine optimizing website portal 10 such that a consumer searching for a particular media content 5 online, or people, places, things and other associations with media content 5 will be directed to website portal 10. Pathway 20 may include a consumer searching for a particular actor or description of a person, event, object or other component of media content 5. Pathway 20 may include a consumer searching for an actor or description of a person, event, or object, the actor or description of a person, event, or object similar to a actor or description of a person, event, or object in media content 5.

Pathway 20 may include links on media content 5 websites, or third party sites that link consumer to website portal 10.

Pathway 30 may include an application 35, for example, for a portable computing device, that allows the consumer to take a picture of a movie title, actor, object, or other images. Pathway 30 may include an application 35 that allows the consumer to choose a move title, television program title, actor, object, event or other component of media content 5 that may be associated with media content 5. Pathway 30 may include an application that allows a consumer to use sound and/or voice recognition to locate an actor, movie, object, event or other component of media content 5 that may be associated with media content 5.

Pathway 40 may include advertising the website address 45 through media content 5, or through other forms of advertising. Pathway 40 may include advertising website address 45 through advertising associated with a motion picture, television program, actor, object, event or other component of media content 5 that may be associated with media content 5. Pathway 40 may include providing website address 45 on motion pictures, television program or other media content 5 or in paraphernalia associated with media content 5. Pathway 40 may include advertising website address 45 via other methods.

Pathway 50 may include using a camera to take a picture of QR code 55. Pathway 50 may include taking a picture of QR code 55, where the QR code is represented in a motion picture, television program or other media content 5 or on an actor, object, event or other component of media content 5 that may be associated with media content 5.

FIG. 1b. schematically depicts a relationship between a website portal and buyers and sellers within an integrated system to purchase products seen in content media, according to an embodiment of the invention.

Each of pathways 20-50, a combination thereof, and/or other pathways, may bring a customer or consumer to website portal 10. In some examples, website portal 10 may provide interfaces for both one or a plurality of consumers, putative buyers, interested buyers, potential buyers and/or buyers, hereinafter buyers 60 and one or a plurality of sellers 70 of a product 200. Sellers 70 may include entities that are supplying product 200 to be sold, entities that are advertising product 200 to be sold, entities that own or control the media wherein product 200 to be sold is seen by a consumer, and other entities within a selling supply chain of product 200.

FIG. 1c is a schematic illustration of an interface for sellers of a product within an integrated system to purchase products seen in content media, according to an embodiment of the invention.

An interface 75 for sellers 70 may include engines configured to interact with buyers 70. Engines may include software, hardware, other computing components and other components.

A first engine 90 may be configured to automatically, semi-automatically or otherwise search out and provide a first contact with a seller 70. Engine 90 may be configured to extract relevant data from seller 70 and in some examples, provide a contract to delineate the relationship between website portal 10 and seller 70. Engine 90 may extract data relating to nature of seller 70's business, the location of the business, the type of products 80 seller 70 intends to sell, and other information. Engine 90 may include real-time interfaces with representative of website portal 10. Engine 90 may include videos, text and other demonstrations of a business model of website portal 10. Engine 90 may include the ability to search the world wide web and/or internet for potential sellers 70.

Engine 90 may be configured to contact sellers 70 automatically, or in some examples, to create lists and/or databases users to manually contact sellers. Engine 90 may be configured to spider the internet periodically to update sellers 70 details and/or to add new sellers 70, among other uses.

In some examples, sellers 70 may sell or otherwise be part of a supply chain for product 200, product 200 appearing or being referenced to in media content 5. In some examples, sellers 70 may sell or otherwise be part of a supply chain for a product related to Product 200. In some examples, sellers 70 may sell or otherwise be part of a supply chain for a product similar to, a duplicate of, or a product having some similarity with product 200.

An Engine 100 may be configured to interface with seller 70. In some examples engine 100 may include software 102, the software configured to aid seller 70 interact with web portal 10. In some examples, software 102 may include different interfaces depending on the media type that displays the item to be sold. In some examples, software 102 may include capabilities to annotate video, providing data for each frame or sets of frame of a video regarding products to be sold. In some examples, software 102 may provide data for identifying a video. In some embodiments of the invention, editors, affiliated with media content 5, or independent editor may use software 102 to drag and drop products 200 and related data into a timeline of media content 5 such that product 200 may become related with a temporal position in media content, and/or other products people, actors, places, objects also associated with that temporal position. In some examples, software 200 may be configured to allow editors and/or other users to add additional data and metadata for product 200 associated with the timeline.

In some examples, an engine 104 may be configured to track sales of a product sold by seller 70 through an interface with buyer 60. Engine 104 may also be configured to track sales of related product of seller 70. Engine 104 may be configured to track supply chain of seller 70, providing, in some examples, options to seller 70 to optimize a supply chain for a particular product given a set of externalities, the externalities may include data regarding an actor associated with a product, data regarding media content 5 associated with a product, trend data associated with the product, and/or other data that might be used to predict product sales.

In some examples, an engine 106 may be configured to automatically, semi-automatically, manually, curatably, or otherwise locate and catalogue products and product sources within media content 5. In some examples, engine 106 may have image comparison software that might interface with databases of known products. In some examples, databases of known products may be provided by entities associated with media content 5, e.g., a prop department. In some examples a database of known products may come from a third party source. In some examples other sources of data regarding products may be referenced or cross referenced by engine 106.

In some examples, engine 106 may search and collect instances of products within media content 5 for later cataloging and cross-referencing products.

FIG. 1d is a schematic illustration of the software for a seller within an integrated system to purchase products seen in content media, according to an embodiment of the invention.

Software 102 may include an editable representation of media content 5. Editable representation may have additional metadata added to aid in the usage of the software 102, including timeline 118.

In some embodiments of the invention, a user of software 102 may select one or a plurality of objects within a frame 108. Frame 108 may coincide with a frame of film or may be an extraction of time, e.g., from 0.1 to 30 seconds in length. In some examples, the frame may be longer. In some examples the frame may be shorter in duration. Frame 108 may include numerous objects 112. Objects 112 may be the same, similar, related to or unrelated to product 200.

In some examples, software 102 may highlight selectable objects 112. In some examples, an editor may select objects 112. In some examples, objects 112 may be selectable by clicking on them. In some examples, objects 112 may be selectable by tracing around them.

A user of software 102 may create links 114 between objects 112 that are visible within frame 102 A user of software 102 may also sever links 114 between objects 112. In some examples, software 102 may present links between objects 112 to a user. A user may be prompted to keep or selectively keep links 114. In some examples a user of software 102 may create links with objects 112a that may not be in frame. In some examples a user of software 102 may add data 116 in relationship to object 112. In some examples data 116 may include descriptive data regarding object 112, in some examples data 116 may include web addresses and or other information that may be relevant to selling object 112 or a similar object. In some examples, data 116 may include information created by software 102 and placed in data 116 automatically, semi-automatically or manually by a user, the information relating to other objects in frame 107, the temporal location of object 112, information regarding media content 5 and other information. A user of software 102 may chose to delete, supplement or maintain data 116.

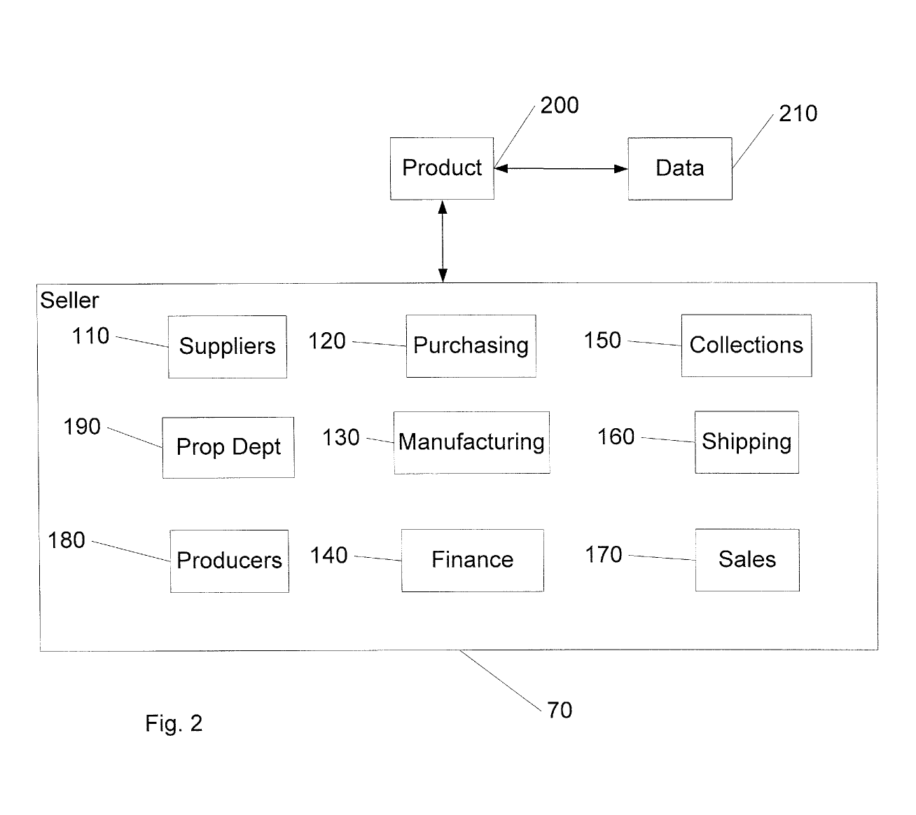

FIG. 2 is a schematic illustration of the interrelationships within a seller group within an integrated system to purchase products seen in content media, according to an embodiment of the invention.

Seller 70 may include one or a plurality of entities. In some examples the entities may be distinct. In some examples, the entities may be related. In some examples the entities may overlap. In some examples, the entities may be fewer or greater in number than those depicted in FIG. 2.

Seller 70 may include one or a plurality of suppliers 110. In some examples seller 70 may include a purchasing department 120. In some examples, seller 70 may include a manufacturing department 130. Seller 70 may include a finance department 140. Seller 70 may include a collections department 150. In some examples, seller 70 may include a shipping department 160. Seller 70 may include a sales department 170.

Seller 70, sales department 170, and/or one or a plurality of suppliers 110 may interact with one or a plurality of producers 180 and or one or a plurality of property departments 190, affiliated with the content media industry. In some examples, Seller 70, including sales department 170, and/or one or a plurality of suppliers 110 may approach producers 180 and/or one or a plurality of property (prop) departments 190 and request one or a plurality of samples of products 200 and/or request purchasing information for one or a plurality of products 200 that may appear in a media content 5. Seller 70 and/or an entity within seller 70 may interface with software 102. In some embodiments of the invention, producer 180 and/or property department 190 of media content 5 may interface directly with software 102, as described above. In some examples, Producer 180 and/or prop department 190 of media content 5 and/or seller 70 may input data 210 into software 102. The data may be related to one or a plurality of samples of products and/or one or a plurality of products that may appear in media content 5.

As described above, data, e.g., data 210 may include name, descriptor, wholesale, discount, and/or retail price of product 200. Data 210 may include information regarding the supply chain of product 200. Data 210 may include information regarding product 200's dimensions and/or colors. Data 210 may include one or a plurality of images, pictures, three dimensional images and/or video associated with the product. Data 210 may also include social media data and metadata associated with product 200. Data 210 may also include contact information for Seller 70 and/or an entity within seller 70. Data 210 may include location and descriptor information regarding product 200 as it appears in media content 5. Data 210 may include actors and movies associated with product 200 or other popular culture references associated with product 200. Data 210 may include the composition of product 200 and/or its component materials. Data 210 may include information regarding related products, other products that may be similar to product 200, the similarities may be related to media content associated with product 200, the similarities may be related to color, style, composition or other physical or implied characteristics of product 200, and/or the similarities may be related to other products that may match complement, or may otherwise be associated with product 200. Ins some examples, data 210 may include information regarding other products unrelated to product 200 but may nevertheless be marketed with product 200.

In some examples, a supplier of product 200 may provide data 210 regarding product 200. In some examples, a third party and/or entity may provide data 210 regarding product 200. In some examples, software may be employed to automatically or semi-automatically collect and store data 210 regarding product 200.

In some examples, seller 70, sales department 170, and/or one or a plurality of suppliers 110 may interact with one or a plurality of producers 180 and or one or a plurality of prop departments 190 may be in communication with one or a plurality of each other.

Seller 70, sales department 170, and/or one or a plurality of suppliers 110 may interact with one or a plurality of producers 180 and or one or a plurality of prop departments 190 may have contracts or agreements that bind them to sell, provide and/or annotate date regarding product 200 exclusively, semi-exclusively or non-exclusively with each other or with another party.

Typically buyer 60 may interface with one or a plurality of Seller 70, sales department 170, and/or one or a plurality of suppliers 110, one or a plurality of producers 180 and or one or a plurality of prop departments 190. A buyer may access one or a plurality of these entities through a website or other source.

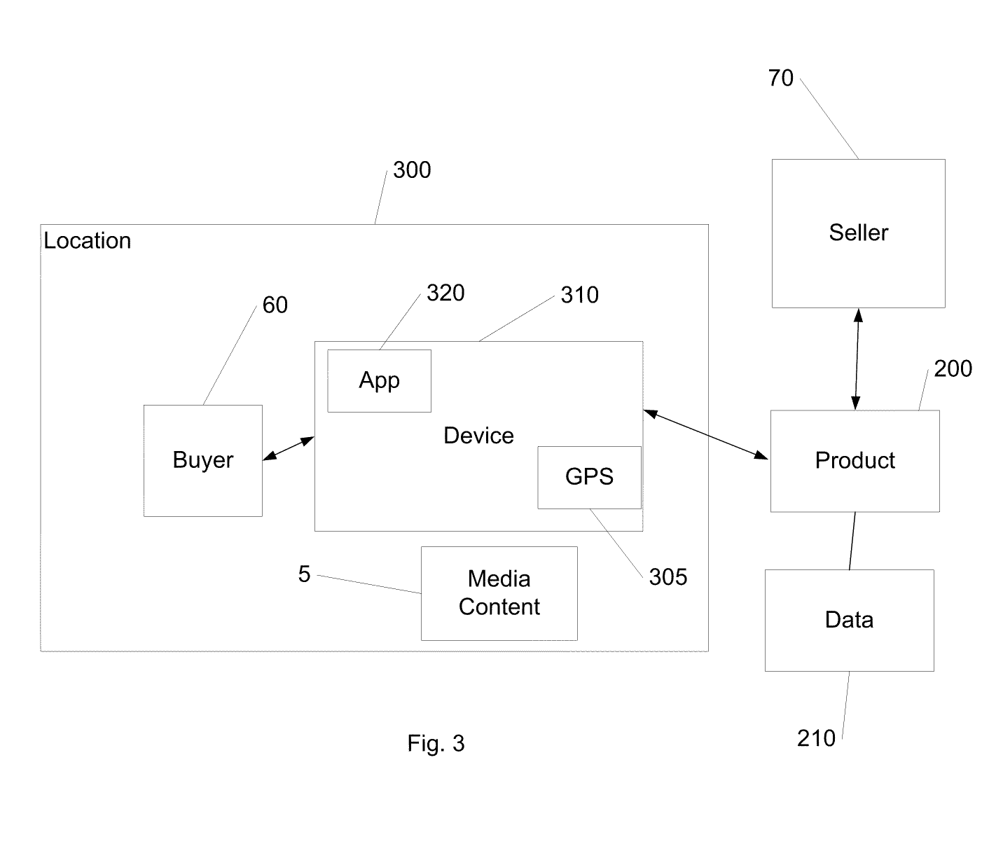

FIG. 3 is a schematic illustration of an interaction with a buyer within an integrated system to purchase products seen in content media, according to an embodiment of the invention.

In some embodiments of the invention, buyer 60 may use a device 310, for example a handheld device such as a phone, cellular phone, smartphone, tablet or other computing device to interface with a seller 70. Buyer 60 may be at a location 300, for example a cinema or at another location, the location typically distinct from the location of seller 70, the location may be associated with watching media content 5. Media content 5 may be audio, visual or audio/visual. Media content 5 may be a film, a television program, an advertisement, a music video or other form of media.

In some examples, device 310 may have the ability to interact with a global positioning system (GPS) 305. In some examples, device 310 may have the ability to record audio and/or visual information. In some examples, device 310 may have the ability to interact with a buyer 60. In some examples device may run an application or software program 320.

Application or software program 320 may be configured to provide a buyer 60 with sources of media content 5, e.g., cinemas, via GPS 305. In some examples, application or software program 320 may use audio and/or recording capabilities of device 310 to determine the nature of the media content that may be in proximity to device 310. In some examples, audio and/or voice recognition technologies may be employed by application or software program 320.

Application or software program 320 may use audio and/or video recording and recognition technologies to synchronize application and/or software program 320 with media content 5. Synchronization may result in application or software program 320 becoming configured to determine what products are currently viewable or related to media content 5.

Application or software program 320 may provide a textual and/or graphical interface, the interface may be synchronized with media content 5. Buyer 60 may be presented by application or software program 320 with purchasing options. In some examples the purchasing options may be synchronistic with media content 5.

Application or software program 320 may provide buyer 60 with an option to chose a product from a clip, the clip may be representative of media content 5 and may be in synch with media content 5. Buyer 60 may be presented with an option to purchase a product from one or a plurality of photos, the photos may be in synch with media content 5. Buyer 60 may be presented with an option to purchase a product from one or a plurality of 3D renderings of the product, the 3D renderings of the product may be in synch with media content 5, or other presentations. Data 210, or portions thereof of the product may be presented, in some examples, in synch with media content. Data 210 may include size and other dimensions of the product, color of the product, or alternative available colors of the product, sale price of the product, discounted sale price of the product, comparative prices of the product, summary information about the product, composition of the product, and/or other information about the product. Media content 5 related information regarding the product may also be presented. Media content 5 related information may include actor association with the product, media content association with the product, location of the product within the media content, association of the product outside of current media content 5 but with other media content.

In some examples data 210 may include information regarding whether the product is part of a larger collection, group, style, whether there are matching or ensemble products, whether there are similar products and/or whether there are suggested products.

Buyer 60, using application or software program 320, or another interface, for example a third party software such as paypal, may be able to purchase the product, save the product for purchasing later, place the product on hold or in a wish list, or email, text, tweet, or relay information regarding one or a plurality of details of the product.

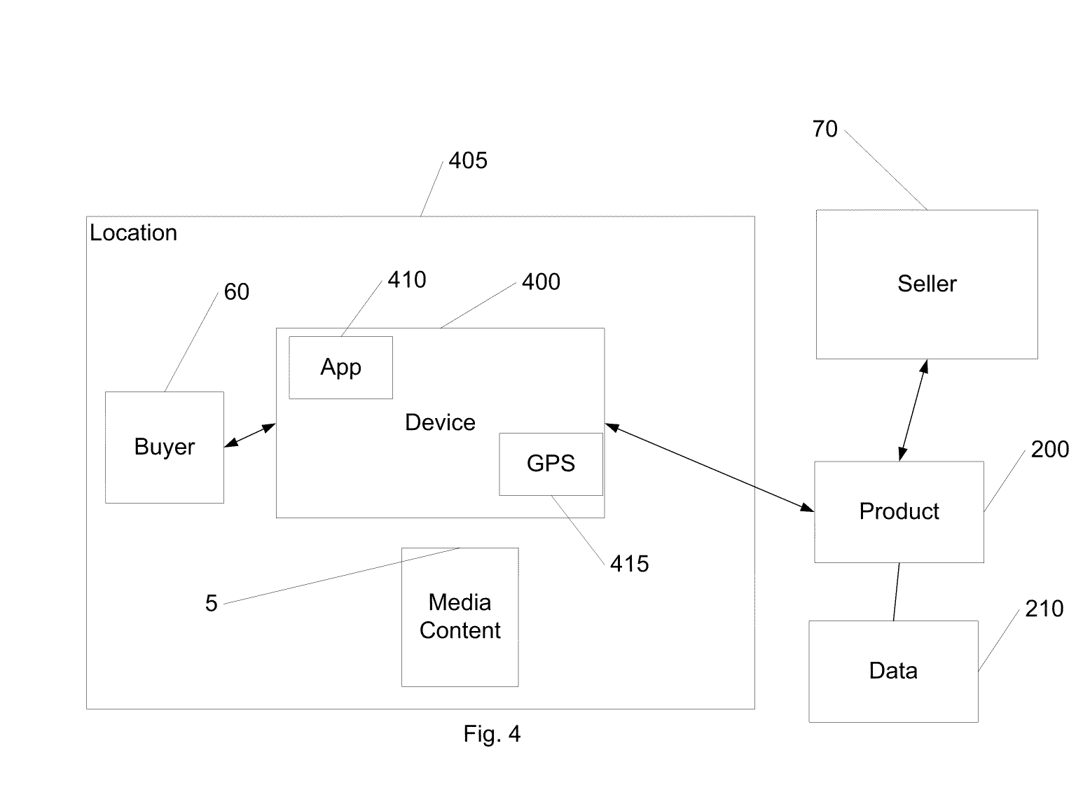

FIG. 4 is a schematic illustration of a method using a device at a location, within an integrated system to purchase products seen in content media, according to an embodiment of the invention.

In some examples, buyer 60 may interface with a device 400, e.g., a desktop computer, tablet computer, portable computer or other computer or computing device. Buyer 60 may be at a location 405, for example, in their home, another private home or in a non-commercial, or in some embodiments of the invention, a commercial setting where media content 5 may be provided, distinct from being provided through a cinema. Buyer 60 may be able to access an application or software program 410, in some examples via device 400.

Application or software program 420 may provide buyer 60 with an interface to the internet and/or the world wide web to view, shop, purchase and/or link to products associated with media content 5. Application or software program may interface with GPS 415.

Application or software program 420 may provide a textual and/or graphical interface, the interface may be synchronized with media content 5. Buyer 60 may be presented by application or software program 420 with purchasing options. In some examples, the purchasing options may be synchronistic with media content 5 being played.

Application or software program 420 may provide buyer 60 with an option to purchase a product 200, typically from seller 70. In some examples, buyer 60 may choose a product from a clip, the clip may be representative of media content 5 and may be in synch with media content 5. Buyer 60 may be presented with an option to purchase a product from one or a plurality of photos, the photos may be in synch with media content 5, one or a plurality of 3D renderings of the product, the 3D renderings of the product may be in synch with media content 5, or other presentations. Data 210 of the product may be presented, in some examples, in synch with media content. Data 210 may include size and other dimensions of the product, color of the product, or alternative available colors of the product, sale price of the product, discounted sale price of the product, comparative prices of the product, summary information about the product, composition of the product, and/or other information about the product. Media content 5 related information regarding the product may also be presented. Media content 5 related information may include actor association with the product, media content association with the product, location of the product within the media content, association of the product outside of current media content 5 but with other media content.

In some examples data 210 may include information regarding whether the product is part of a larger collection, group, style, whether there are matching or ensemble products, whether there are similar products and/or whether there are suggested products.

Buyer 60, using application or software program 420, or another interface, for example a third party software such as paypal, may be able to purchase the product, save the product for purchasing later, place the product on hold or in a wish list, or email, text, tweet, or relay information regarding one or a plurality of details of the product.

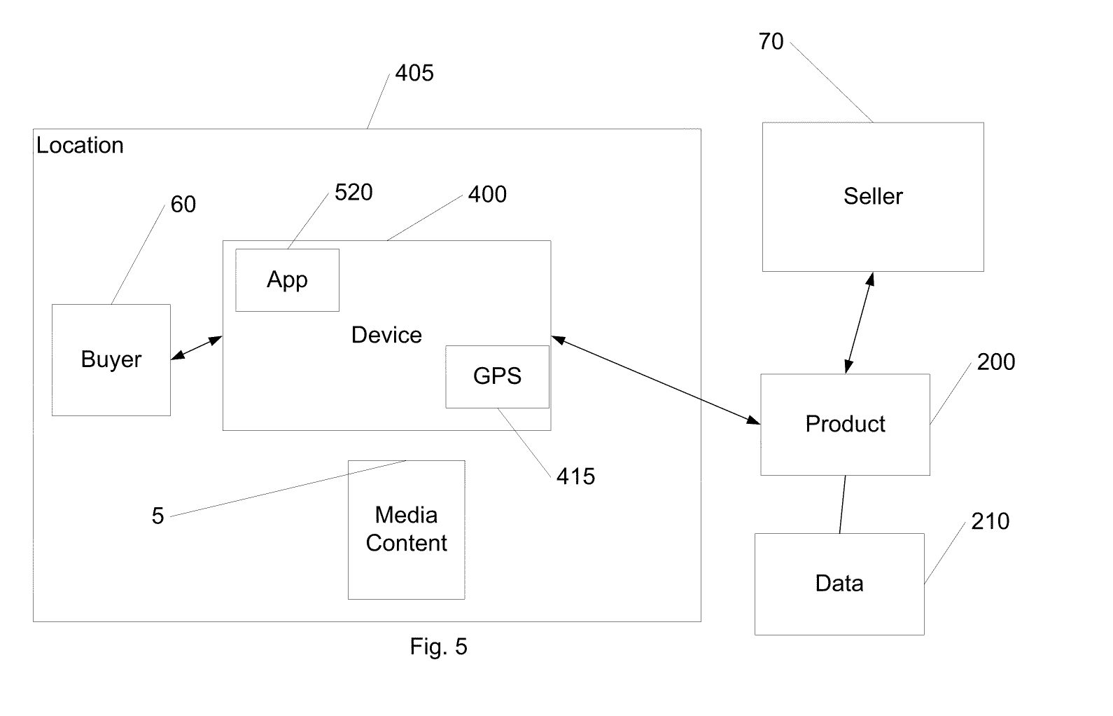

FIG. 5 is a schematic illustration of method using a device at a location within an integrated system to purchase products seen in content media, according to an embodiment of the invention.

In some examples, buyer 60 may interface with a device 400, e.g., a desktop computer, tablet computer, portable computer or other computer or computing device. Buyer 60 may be at a location 405, for example, in their home, another home or in a non-commercial or commercial setting where media content 5 may be provided. Buyer 60 may be able to access an application or software program 520, in some examples via device 400.

Application or software program 520 may use audio and/or video recording and recognition technologies, the technologies may be components of computers of computing devices, or may be peripheral to computers or computing devices, to synchronize application and/or software program 520 with media content 5. For example, when media content 5 may be broadcast over a private broadcasting system, when media content 5 is broadcast over a closed circuit broadcasting system, when media content 5 is broadcast over a commercial, non cinematic broadcasting system, or other broadcasts of media content 5.

Application or software program 520 may provide buyer 60 with an interface to the internet and/or the world wide web to view, shop, purchase and/or link to products associated with media content 5.

Application or software program 520 may provide a textual and/or graphical interface, the interface may be synchronized with media content 5. Buyer 60 may be presented by application or software program 520 with purchasing options. In some examples the purchasing options may be synchronistic with media content 5.

Application or software program 520 may provide buyer 60 with an option to choose a product from a clip, the clip may be representative of media content 5 and may be in synch with media content 5. Buyer 60 may be presented with an option to purchase a product from one or a plurality of photos, the photos may be in synch with media content 5, one or a plurality of 3D renderings of the product, the 3D renderings of the product may be in synch with media content 5, or other presentations. Data 210 of the product may be presented, in some examples, in synch with media content. Data 210 may include size and other dimensions of the product, color of the product, or alternative available colors of the product, sale price of the product, discounted sale price of the product, comparative prices of the product, summary information about the product, composition of the product, and/or other information about the product. Media content 5 related information regarding the product may also be presented. Media content 5 related information may include actor association with the product, media content association with the product, location of the product within the media content, association of the product outside of current media content 5 but with other media content.

In some examples data 210 may include information regarding whether the product is part of a larger collection, group, style, whether there are matching or ensemble products, whether there are similar products and/or whether there are suggested products.

Buyer 60, using application or software program 520, or another interface, for example a third party software such as paypal, may be able to purchase the product, save the product for purchasing later, place the product on hold or in a wish list, or email, text, tweet, or relay information regarding one or a plurality of details of the product.

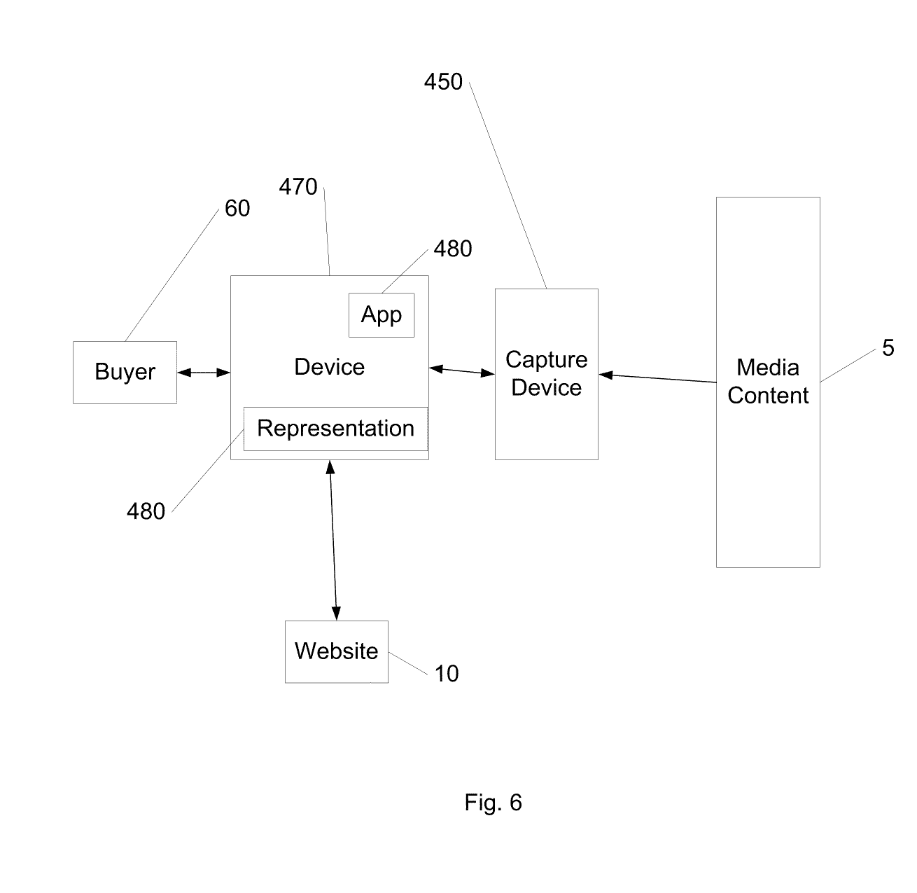

FIG. 6 is a schematic illustration of a method for media content capture within an integrated system to purchase products seen in content media, according to an embodiment of the invention.

In some examples buyer 60 may access website portal 10 from one or a plurality of interfaces. In some examples, buyer 60 may use a capture device 450 such as camera, and/or microphone to capture a component or a representative component of media content 5. Capture device 450 may interface with a portable computing device 470. Portable computer device may be configured or, in some examples, may contain software or an application 480 that interfaces with website portal 10.

In some examples, buyer 60 may use a computing device to interface with website portal 10. In some examples, buyer 60 may use a portable computing device 470, the portable computing device capable of determining the location of buyer 60, or configured to interface with a peripheral that can determine the location of buyer 60. Portable computing device may be configured to interface with website portal 10, may have software or an application 480 that interfaces with website portal 10, or may otherwise interface with website portal 10.

In some examples, buyer 60 may capture a representation of media content 490, and may provide that representation of media content 5 to a computing device. The computing device may be configured to interface with website portal 10, may have software or an application to interface with website portal 10 or may otherwise provide the ability to interface with website portal 10. In some examples, buyer 60 may capture a representation of media content 490 via a computer, a computing tablet, a video and/or audio, an audio recording device, a Smartphone, a handheld computing device, and/or another device that may be used to capture representation of media content 490.

In some examples, media content or representation of media content 490 may be captured from a computer, a tablet computer, a video and/or audio video camera, a television, a monitor, an video and or, audio video projector, a cinema projector, a Smartphone, a mp3 and/or portable music player, a radio or other devices that may present media content or a representation of media content to buyer 60.

Media content or representation of media content 5 may be provided to website portal 10 or a device that may interface with website portal 10 through a database, a magnetic media source, an optical media source, a solid state media source, a portable media source, the internet, the cloud and/or other sources of media content and//or representations of media content 490.

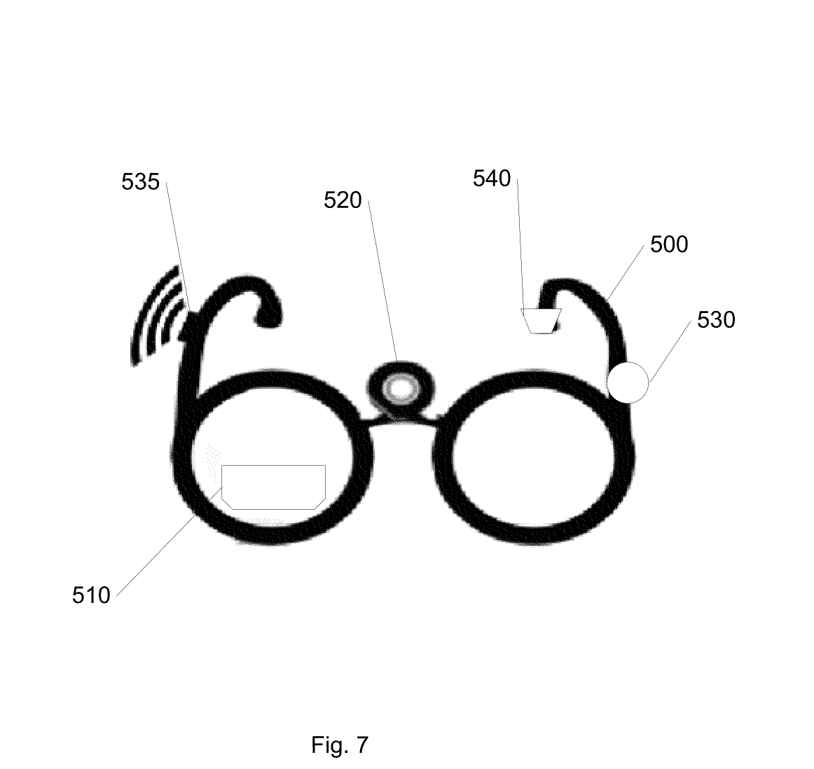

FIG. 7 is a schematic illustration of a device resembling eyeglass for use within an integrated system to purchase products seen in content media, according to an embodiment of the invention.

In some examples a pair of glasses 500 or similar device may be used to interface with website portal 10.

In some examples glasses 500 may contain prescription lenses. In some examples, glasses 500 may contain lenses that are not prescription. In some examples, the glasses may provide a video screen 510. Glasses 500 has audio and/or video inputs including, for example one or a plurality of cameras 520 and/or one or a plurality of microphones 530. Glasses 500 has a component 535 that may provide wireless internet capability and may connect to a portable computing device or to the cloud or other sources of computing, processing, and/or data.

Glasses 500 may be enabled to record audio and/or video and/or images through one or a plurality of methods including through use of an interface on glasses 500, e.g., a depressible button, through a specific pattern of eye movements, e.g., double blinking, through the use of an interface on a portable computing device or other device coupled to glasses 500 and/or through the use of hand motions, the hand motions may be decipherable by an algorithm run by a processor 540, the processor may be coupled to glasses 500 physically or wirelessly.

Glasses 500 may be configured to capture images of media content and to use those images to interface buyer 60 with website portal 10. In some examples, this interfacing may be in conjunction with global positioning or other positioning capabilities.

In some examples, a particular tone, sound and/or image produced by media content in the proximity of buyer 60 may activate glasses 500. Glasses 500 may interface with website portal 10. In some examples, contents of website portal 10 may be viewed by video screen 510, in some examples contents of website portal 10 may be viewed by a computing device.

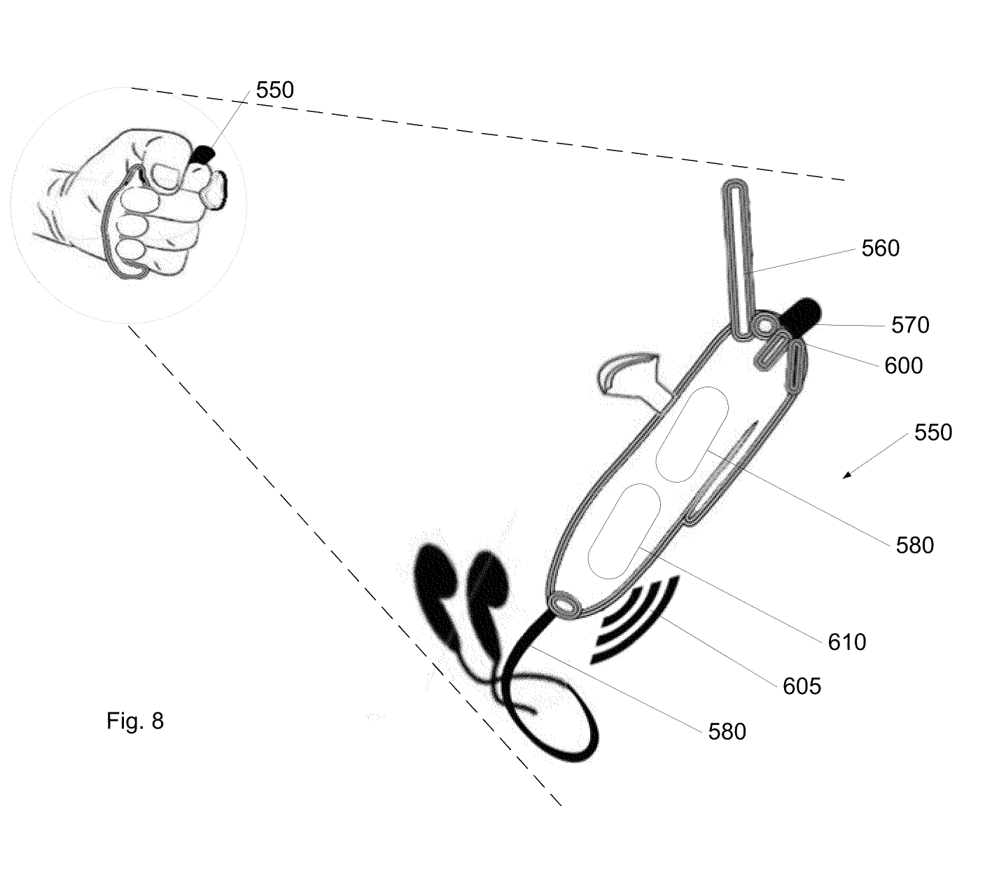

FIG. 8 is a schematic illustration of a handheld device for use within an integrated system to purchase products seen in content media, according to an embodiment of the invention.

The interface may be wired, wirelessly or connected via some form of connection to website portal 10. Device 550 may be a handheld device. Device 550 may be configured to capture video and/or audio. Device 550 may also be configured to be usable as a mouse or a pointing device on a computer, e.g., a portable computing device.

Device 550 has a top handle 560 than can be used as a mouse or mouse-like device for a computing device. Top handle may 560 have buttons similar to buttons on a mouse. Device 550 has a camera coupled to the device to record video and/or images. Device 550 has a microphone 570 coupled to the device to record audio. Device 550 has ports for both inputs and outputs, including ports for audio and/or video output, e.g., sound output 580. Device 550 has a computational unit 580 that may include a processor, memory and other computational components.

Device 550 may be configurable to be used as an audio/video device. Device 550 may be configurable to be used as a portable music player or other secondary and/or primary uses.

Device 550 has laser pointer or sight 600 or other component configurable to position a camera 560 in a desired direction. Device 550 has one or a plurality of directional components 610, including an altimeter, an accelerometer, a gyroscope and/or other components that can be used in motion sensing. Device 550 has infrared, radio, and/or other transmission capabilities, as depicted by transmission waves 605. These transmission capabilities may be configurable such that device 550 can be used as a remote control. Device 550 may have multi-touch capabilities, the multi-touch capabilities may allow a user to interact with device 550 by touching device 550. Device 550 may have a display screen that may be configurable to provide information for a user.

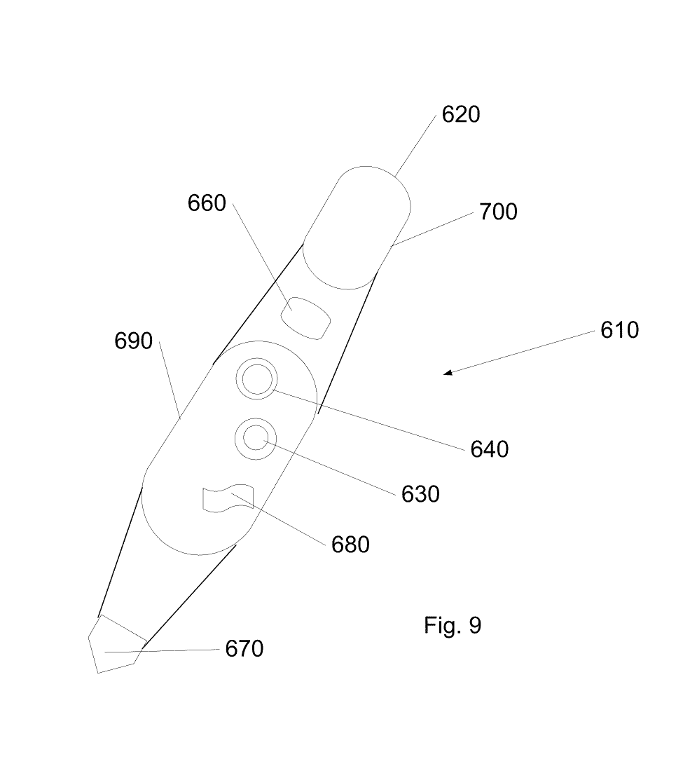

FIG. 9 is a schematic illustration of a device resembling a pen for use within an integrated system to purchase products seen in content media, according to an embodiment of the invention.

Device 610 may be constructed to look like a pen, and/or to function as a pen. Device 610 may interface with website portal 10. The interface may be wired, wirelessly or connectable via some form of connection to website portal 10. Device 610 may be configured to capture video and/or audio.

Device 610 may be configured to capture images of media content and to use those images to interface buyer 60 with website portal 10. In some examples, this interfacing may be in conjunction with global positioning or other positioning capabilities.

Device 610 may also be configured to be used as a mouse, a pointing, a laser pointer and/or another device associated with a computer, e.g., a portable computing device.

Device 610 has a top portion 620 than can be used as a mouse or mouse-like device for a computing device. Top portion 620 has buttons similar to buttons on a mouse. Device 610 has a camera 630 coupled to the device to record video and/or images. Device 610 has a microphone 640 coupled to the device to record audio. Device 610 may have ports for both inputs and outputs, including ports for audio and/or video output. Device 610 has computer processing capabilities within a component 660 that may contain a processor, memory and other devices that may be related to processing. Device 610 may be configurable to be used as an audio/video device. Device 610 may be configurable to be used as a portable music player and/or other secondary and/or primary configurations.

Device 610 has laser pointer or laser sight 670 or other similar component configurable to position camera 630 in a desired direction. Device 610 has one or a plurality of directional components 680, including an altimeter, an accelerometer, a gyroscope and/or other components that can be used for motion sensing. Device 610 may have infrared, radio, and/or other transmission capabilities. These transmission capabilities may be configurable such that device 610 can be used as a remote control. Device 610 may have multi-touch capabilities, the multi-touch capabilities may allow a user to interact with device 610 by touching device 610. Device 610 has a display screen 690 that may be configurable to provide information for a user. Device 610 has one or a plurality of human interfaces 700 for inputting data. Device 610 may have positioning capabilities, e.g., global positioning capabilities.

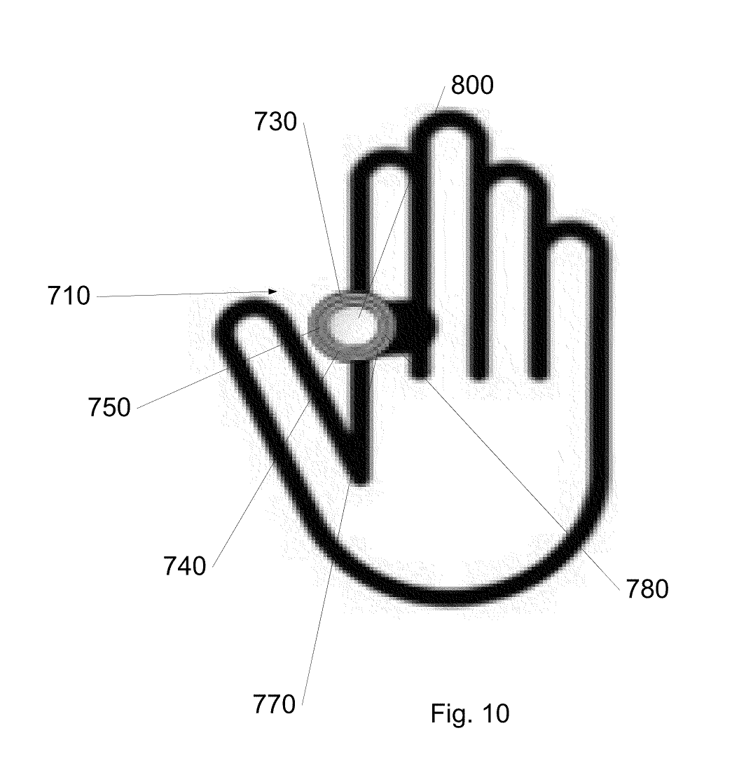

FIG. 10 is a schematic illustration of a device resembling a ring for use within an integrated system to purchase products seen in content media, according to an embodiment of the invention.

Ring 710 and/or other jewelry may be a device configured to interface with website portal 10. The interface may be wired, wirelessly or connectable via some form of connection to website portal 10 including Bluetooth, infrared or other connection methodologies. Ring 710 may be configured to capture images of media content 5 and to use those images to interface buyer 60 with website portal 10. In some examples, this interfacing may be in conjunction with global positioning or other positioning capabilities. Ring 710 may be configured to capture video and/or audio. Ring 710 may also be configured to be used as a mouse, a pointing device, a laser pointer and/or another device associated with a computer, e.g., a portable computing device.

Ring 710 has a camera 730 coupled to the device to record video and/or images. Ring 710 has a microphone 740 coupled to the device to record audio. Ring 710 may have ports for both inputs and outputs, including ports for audio and/or video output. Ring 710 has a processing unit 750 that may contain one or a plurality of processors, memory, and/or other computing components. Ring 710 may be configurable to be used as a audio/video device. Ring 710 may be configurable to be used as a portable music player. Ring 710 has laser 770 or other component configurable to sight or position camera 730 in a desired direction. Ring 710 has one or a plurality of directional components 780, including an altimeter, an accelerometer, a gyroscope and/or other components that can be used in motion sensing. Ring 710 may have infrared, radio, and/or other transmission capabilities. These transmission capabilities may be configurable such that Ring 710 can be used as a remote control. Ring 710 may have multi-touch capabilities, the multi-touch capabilities may allow a user to interact with Ring 710 by touching Ring 710. Ring 710 has a display screen 790 that may be configurable to provide information for a user. Ring 710 has one or a plurality of human interfaces 800 for inputting data.

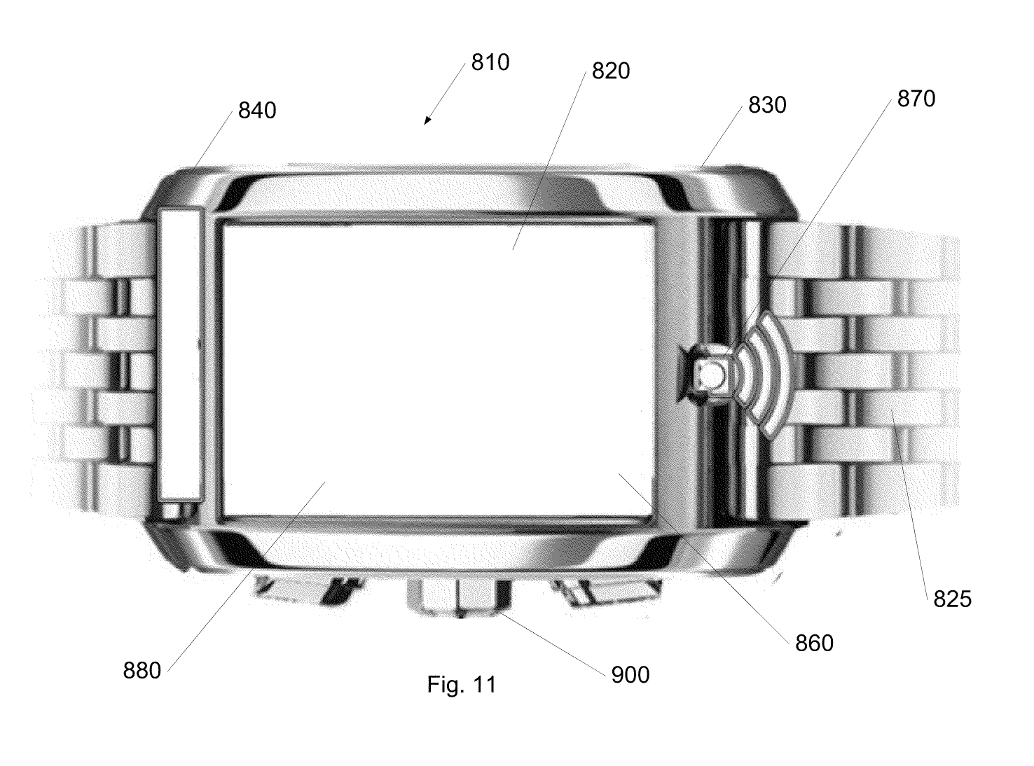

FIG. 11 is a schematic illustration of a watch or watch like device configured to interface with a web portal.

Watch 810 and/or other jewelry, or watch like devices may be a device configured to interface with website portal 10. The interface may be wired, wirelessly or via some form of connection to website portal 10 e.g., infrared or Bluetooth. Watch 810 may be configured to capture images, video and/or audio. Watch 810 may be configured to capture images of media content 5 and to use those images to interface buyer 60 with website portal 10. In some examples, this interfacing may be in conjunction with global positioning or other positioning capabilities.

Watch 810 may also be configured to be used as a mouse, a pointing, a laser pointer and/or another device associated with a computer, e.g., a portable computing device.

Watch 810 has a camera 830 coupled to the device to record video and/or images. Watch 810 has a microphone 840 coupled to the device to record audio. Watch 810 may have ports for both inputs and outputs, including ports for audio and/or video output. Watch 810 has a processing unit 860 that may contain one or a plurality of processors, memory, and/or other components for computational processing. Watch 810 may be configurable to be used as a audio/video device. Watch 810 may be configurable to be used as a portable music player. Watch 810 has laser 870 or other component configurable to position camera 830 in a desired direction. Watch 810 has one or a plurality of directional components 880, including an altimeter, an accelerometer, a gyroscope and/or other components that can be used in motion sensing. Watch 810 may have infrared, radio, and/or other transmission capabilities. These transmission capabilities may be configurable such that Watch 810 can be used as a remote control. Watch 810 may have multi-touch capabilities, the multi-touch capabilities may allow a user to interact with watch 810 by touching the watch face 820 or the watch band 825. Watch 810 has a display screen on watch face 820 that may be configurable to provide information for a user. Watch 810 has one or a plurality of human interfaces 900 for inputting data.

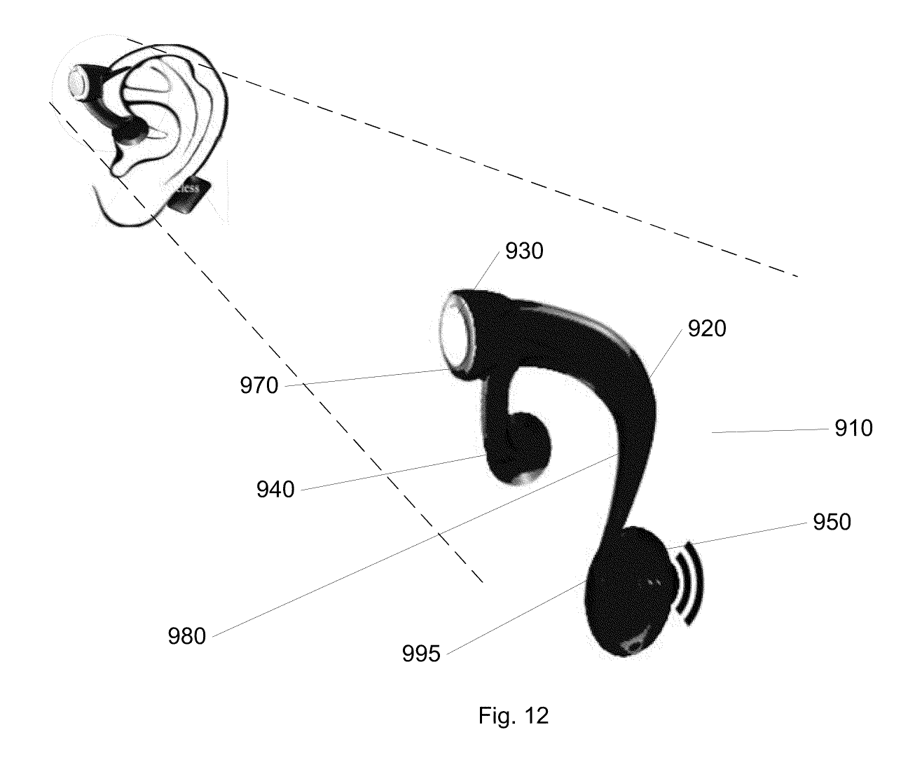

FIG. 12 is a schematic illustration of a ear device, e.g, an earpiece configured to interface with a web portal.

Ear device 910 may be a behind the ear earloop, an earbud, behind the head headset, or other device or jewelry like device that is configured to interface with a human ear, may be a device configured to interface with website portal 10. The interface may be wired, wirelessly or via some form of connection to website portal 10 e.g., infrared or Bluetooth. Ear device 910 may be configured to capture video, images, and/or audio.

Ear device 910 may be configured to capture images of media content 5 and to use those images to interface buyer 60 with website portal 10. In some examples, this interfacing may be in conjunction with global positioning or other positioning capabilities.

Ear device 910 also be configured to be used as a mouse, a pointing device, a laser pointer and/or another device associated with a computer, e.g., a portable computing device, in some examples, a user may move their head to move a pointer on a screen.

Ear device 910 has a camera 930 coupled to the device to record video and/or images. Ear device 910 has a microphone 940 coupled to the device to record audio. Ear device 910 may have ports for both inputs and outputs, including ports for audio and/or video output. Ear device 910 has a processor unit 950 which may include one or a plurality of processors, one or a plurality of memory components and/or other processor related components. Processor unit 950 may be housed in ear device 910 and/or elsewhere but in connection with ear device 910.

Ear device 910 may be configurable to be used as an audio/video device. Ear device 910 may be configurable to be used as a portable music player. Ear device 910 has laser 970 or other component configurable to position camera 930 in a desired direction. Ear device 910 has one or a plurality of directional components 980, including an altimeter, an accelerometer, a gyroscope and/or other components that can be used in motion sensing. Ear device 910 may have infrared, radio, and/or other transmission capabilities. These transmission capabilities may be configurable such that Watch 810 can be used as a remote control. Ear device 910 has multi-touch capabilities, the multi-touch capabilities may allow a user to interact with ear device 910 by touching the a support structure 920, neck band or other support structure, Ear device 910 may have a display screen that may be configurable to provide information for a user. Ear device 910 has one or a plurality of human interfaces 995 for inputting data.

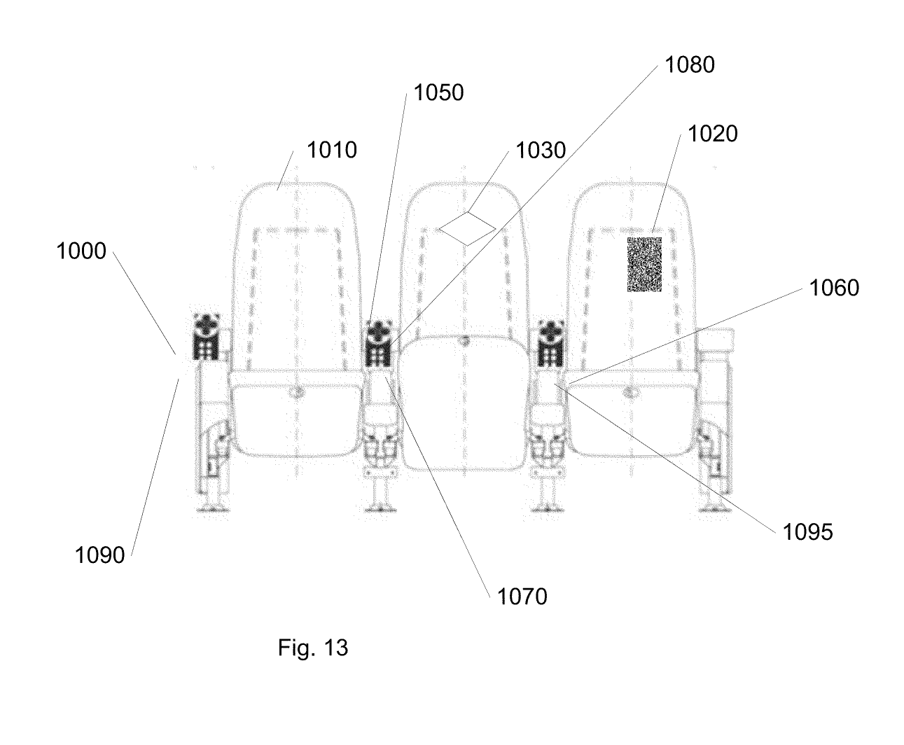

FIG. 13 is a schematic illustration of a device coupled to a seat in a cinema, the device configured to interface with a web portal.

In some examples buyer 60 may interface with web portal 10 through a device 1000 coupled to a seat 1010. In some examples, the seat may be in a cinema. In some examples the seat may be in a private home or on a vehicle, including an airplane or a form of public and/or private transportation.

Seat 1010, or a device 1030 coupled to seat 1010, has a unique code 1020, e.g., a QR code or another uniquely identifying feature, Buyer 60 may take a picture of this identifying feature and have the image of the feature inputted in to their hand held computing device.

Device 1030 may be coupled to an audio or video feed for media content 5, the media content 5 to be displayed to a user situated in seat 1010. In some examples, device 1000 may be synchronized with media content 5. In some examples, device 1000 may provide buyer 60 with capabilities that allows buyer 60 to purchase products 200 associated with media content 5. In some examples, device 1000 may provide buyer 60 with capabilities that lets buyer 60 save scenes or products from scenes to be viewed and/or purchased at another time, In some examples, device 1000 may be coupled via wires, wirelessly, via infrared, Bluetooth or other communication technologies to a hand held computing device, e.g., a tablet computer, a smartphone, a smart watch or other device. In some examples, device 1000 may be coupled via wires, wirelessly, via infrared, Bluetooth or other communication technologies to the cloud or to a particular location on the cloud, the location associated with buyer 60.

In some examples device 1000, typically when used on a small or private screen, may have capabilities to point and select products viewed in media content 5. In some examples device 1000 may have a pointer, laser or other function that allows buyer 60 to aim the device at a product in media content 5.

Device 1000 has a camera 1050 coupled to the device to record video and/or images from media content 5. Device 1000 has a microphone 1060 coupled to the device to record. Device 1000 may have ports for both inputs and outputs, including ports for audio and/or video output. Device 1000 has a processor unit 1070 that may contain one or a plurality of processors, one or a plurality of memory and/or other components used in n computational processing. processor unit 1070 is housed in device 1000 and/or elsewhere but in connection with device 1000.

Device 1000 has laser 1090 or other component configurable to position camera 1050 in a desired direction. Device 1030 has one or a plurality of directional components 1095, including an altimeter, an accelerometer, a gyroscope and/or other components that can be used in motion sensing Device 1000 may have infrared, radio, and/or other transmission capabilities. These transmission capabilities may be configurable such that it can communicate with other nearby devices. Device 1000 may have multi-touch capabilities, the multi-touch capabilities may allow a user to interact with Device 1000. Device 1000 has a display screen 1100 that may be configurable to provide information for a user. Device 1000 has one or a plurality of additional human interfaces 1080 for inputting data.

In some examples, a buyer 60 may enter a movie theater carrying a mobile computing device, e.g., a Smartphone, a tablet, glasses 500, Ear device 910, watch 810, Ring 710, device 610 other devices described above and/or other devices. The Smartphone may be running an application or software that may be configured to interface with a website portal.

When buyer 60 enters the movie theatre the Smartphone running the application may signal to the buyer to activate a software program. In some examples, Smartphone may employ localization technology, e.g., a global positioning system to determine that buyer 60 is in a movie theatre. In some examples, when buyer 60 purchases a movie ticket at a movie theatre with a credit card coupled to website portal 10, the Smartphone may signal to the buyer to activate a software program. In some examples when buyer 60 uses a Smartphone to capture an image of a movie poster or a QR code or an advertisement associated with media content 5 or a movie theatre, the Smartphone may signal to buyer to activate a software program. In some examples, buyer 60 may take a picture of a ticket for a movie with a Smartphone, the Smartphone may signal buyer 60 to activate software.

When buyer 60 activates the software, the software interfacing with website portal 10, buyer 60 may be signaled to confirm a movie and a start time.

In some examples, buyer 60 may not need to confirm movie and/or start time of the movie or other media content 5.

In some examples, software on the Smartphone may automatically synchronize media content 5 with known media content 5 from a database. In some examples, synchronization may occur via audio synchronization. Audio synchronization may include synchronizing audio inputs from the media content 5 played in the theater with know media content 5 in a database. In some examples, synchronization may occur via video synchronization. Video synchronization may occur by synchronizing video captured by the Smartphone in the theatre with known video. In some examples both audio and video synchronization may occur.

In some examples the Smartphone may confirm synchronization periodically, e.g., every five minutes. In some examples this amount of time may be shorter. In some examples, this amount of time may be longer.

Software on Smartphone may signal to Smartphone to place ringer on mute, darken the Smartphone screen, among other changes to a status quo of the Smartphone.

Buyer may indicate throughout the movie which items they would like to purchase by tapping the Smartphone. In some examples, buyer may indicate which items they might like to purchase by maneuvering the Smartphone. The maneuvers of the Smartphone may typically be interpreted by localization components within the Smartphone including accelerometers, gyroscopes and other components.

Once buyer 60 has indicated a preference for a product within a movie, the Smartphone may record a short portion of the movie capturing the scene in which a product of interest occurs. In some examples this recording may last two to five. In some examples, this recording may be longer or shorter. In some examples a list of products that may be purchased from the indicated scene may be compiled and texted, emailed or otherwise sent to buyer 60 or to a third party.

In some examples buyer 60 may be prompted to review saved scenes after the completion of the movie. buyer 60 may use an interface on the smartphone to select, save, purchase or send messages regarding products in the saved scenes.

In some examples buyer 60 may synchronize an application or software associated with one or a plurality of devices, including, a portable computing device, a non-portable computing device, a tablet computer, a smartphone, glasses 500, Ear device 910, watch 810, Ring 710, device 610, other devices described above and/or other devices with a television or other device showing media content. In some examples, the application or software may be configurable to remotely control the television.

In some examples, the application or software may be configurable to synchronize with the current television programming in real or near real-time. In some instances the application or software may be configurable to be synchronized with recorded programming and/or media content 5.

The application or software may use temporal data regarding the programming or media content 5 to synchronize. In some instances, the application or software may use audio and/or visual information collected in real time through an audio and/or video input of the device associated with the software and/or hardware.

In some examples, buyer 60 may choose to manually synchronize the media content 5 with the software package or application 35.

While viewing the media content 5, buyer 60 may select scenes or products to buy, or place in a virtual shopping cart, or to place on a virtual wish list or to otherwise retain for later viewing.

In some examples the recorded scene may last two to five seconds. In some examples, this recording may be longer or shorter. In some examples a list of products that may be purchased from the indicated scene may be compiled and texted, emailed or otherwise sent to buyer 60 or to a third party. This list may be emailed after every recorded scene, after a set number of scenes, or at the end of the media content 5 being viewed, or when buyer 60 shuts off the software package or application 35, and/or the device associated with the software package or application 35.

In some examples buyer 60 may be prompted to review saved scenes after the completion of the movie. Buyer 60 may use an interface with the software package or application 35 to select, save, purchase or send messages regarding products in the saved scenes.

In some examples, buyer may view media content 5 on a computing device, for examples, a home computer, a tablet computer, a smartphone, a smart watch, a game system, a portable computer, or other device configurable to view media content 5.

In some examples, buyer may download a software package or application 35 to interface with website portal 10.

Software package or application 35 interfacing with website portal 10 may be configured to run in the background, or may be configured to run only when activated by buyer 60.

Buyer 60 may use the computing device to view media content 5.

In some examples, when buyer 60 views media content 5 on a computing device, the software package or application 35 may signal to buyer 60 that it has started, or may need to be started manually.

When software package or application 35 is started, it may determine automatically, semi-automatically or manually what the media content 5 is being viewed by buyer 60. In some examples, an automatic determination may include using data from a database, including data related to length of media content 5, start and end time of media content 5 and any interruptions expected in the playback of media content 5, e.g., commercials. The database may include a copy of the media content 5, that copy may be used by the software package or application 35 or website portal 10 to display saved scenes to buyer 60. In some examples, software package or application 35 may automatically synchronize with media content 5 via recording and decoding audio and/or visual data from content media and cross referencing the recorded and/or decoded audio and/or visual with a database. The database may contain a copy of the content media, or may contain meta data regarding the content media including information regarding broadcast times and actors and other metadata that could be used to determine the exact nature of the content media. In some applications, once the content media has been determined by the software package or application 35, the software package or application 35 may prompt and/or signal buyer 60 to confirm.

In some instances, software package or application 35 may signal buyer 60 to input some data regarding the media content 5 including source of media content 5, temporal data, production data, and other information related to media content 5. Software package or application 35 may use this data to cross reference a database to determine the identity of the media content 5. In some examples, a list of potential matches may be provided by software package or application 35; buyer 60 may be prompted to select the correct match. Software package or application 35 may use data inputs, including audio and/or visual data to synchronize with the media content 5.

Buyer 60 may use an interface, for example the touch screen on the computing device or a pointing device to select scenes or products from scenes of interest.

In some examples selecting a product or scene may open up a secondary window on the computing device with data relating to the product. In some examples, this secondary window may not open until the content media has completed, at which point buyer 60 may be prompted as to whether a secondary window should be opened. Typically, the secondary window will open to web portal 10 or a local interface with website portal 10.

Examples of the present invention may include apparatuses for performing the operations described herein. Such apparatuses may be specially constructed for the desired purposes, or may comprise computers or processors selectively activated or reconfigured by a computer program stored in the computers. Such computer programs may be stored in a computer-readable or processor-readable non-transitory storage medium, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions. It will be appreciated that a variety of programming languages may be used to implement the teachings of the invention as described herein. Examples of the invention may include an article such as a non-transitory computer or processor readable non-transitory storage medium, such as for example, a memory, a disk drive, or a USB flash memory encoding, including or storing instructions, e.g., computer-executable instructions, which when executed by a processor or controller, cause the processor or controller to carry out methods disclosed herein. The instructions may cause the processor or controller to execute processes that carry out methods disclosed herein.

Different embodiments are disclosed herein. Features of certain embodiments may be combined with features of other embodiments; thus certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1-7. (canceled)

8. A system for selling products associated with a content media, the system comprising:
an interface to add metadata for a product into the content media and to associate it with an object appearing in the content media, the metadata relating to a product for sale; and,
a data processing system comprising a processing unit in communication with a non-transitory computer usable medium, wherein the non-transitory computer usable medium comprises instructions of an application, which when executed by a computing device allows a buyer to use the computing device for selecting the object and facilitating an interaction relating to the product.

9. The system of claim 8, wherein the computing device is a portable computing device.

10. The system of claim 9, wherein the portable computing device is selected from the group of portable computing device consisting of a smartphone, a computer, a pair of glasses, a watch, a ring, an in ear device, and a device coupled to a seat in a cinema.

11. The system of claim 8, wherein the interface is configured to allow annotating of the content media.

12. The system of claim 8, wherein the instructions when executed cause a processor to synchronize the application with content media.

13. The system of claim 12, wherein the system further comprises hardware for synchronizing application with the content media.

14. The system of claim 8, wherein a website facilitates the interaction relating to the product.

15. A non-transitory computer readable medium comprising instructions, which when executed by a processor of a computing device cause the processor to allow a buyer to use the computing device for selecting an object appearing in a content media in which metadata for a product has been added, the metadata associated with the object and relating to a product for sale, and facilitating an interaction relating to the product.

16. The non-transitory computer readable medium of claim 15, wherein the instructions, when executed, cause the processor to allow a seller to add the metadata associated with the object and relating to a product for sale for the object appearing in the content media.

17. The non-transitory computer readable medium of claim 15, which when executed by a processor of a computing device, cause the processor to allow annotating of the content media.

18. The non-transitory computer readable medium comprising instructions of claim 15, which when executed by a processor of a computing device, cause the processor to synchronize an application with the content media.

19. A method of selling products associated with a content media, the method comprising:
adding metadata for a product into the content media and associating the metadata with an object appearing in the content media, the metadata relating to a product for sale via an interface; and,
executing instructions of an application by a computing device to allow a buyer to use the computing device for selecting the object and facilitating an interaction relating to the product.

20. The method of claim 19, wherein the computing device comprises a portable computing device.

21. The method of claim 20, wherein the portable computing device is selected from the group of portable computing device consisting of a smartphone, a computer, a pair of glasses, a watch, a ring, an in ear device, and a device coupled to a seat in a cinema.

22. The method of claim 19, wherein the interface is configured to allow annotating of the content media.

23. The method of claim 19, wherein executing instructions of an application comprises synchronizing the application with the content media.

24. The method of claim 23, wherein the method further comprises employing hardware for synchronizing the application with the content media.

25. The method of claim 19, wherein a website is provided for facilitating the interaction relating to the product.

26. The method of claim 25, wherein the application accesses the website through an image that is representative of the product in the content media.

27. The method of claim 25, wherein the application accesses the website through a recognition technology.
